(19) United States
(12) Patent Application Publication
(10) Pub. No.: US 2024/0262022 A1
(43) Pub. Date: Aug. 8, 2024

(54) INJECTION DEVICE

(71) Applicant: FANUC CORPORATION, Yamanashi (JP)

(72) Inventor: Takuto YAMAWAKI, Yamanashi (JP)

(73) Assignee: FANUC CORPORATION, Yamanashi (JP)

(21) Appl. No.: 18/564,991

(22) PCT Filed: Jun. 7, 2021
(86) PCT No.: PCT/JP2021/021624

§ 371 Date: Nov. 28, 2023

(51) Int. Cl. B29C 45/53; B29C 45/76

(52) U.S. Cl. CPC B29C 45/531; B29C 45/76; B29C 2945/76013; B29C 2945/76083; B29C 2945/7618; B29C 2945/76367

(57) ABSTRACT

The present invention provides an injection device which is capable of injecting a certain amount of a resin material in each injection process, while suppressing entry of air into a barrel and cost increase due to increase in the number of components. An injection device 1 according to the present invention is provided with: a resin material inlet 13; a drive unit 20 which generates a driving force for injecting a resin material from an injection port 12; a plunger 17 which is provided so as to be movable forward and backward in the axial direction of a barrel 11, and moves backward when the resin material flows into the barrel 11 and injects the resin material filled in the barrel 11 through the injection port 12 by moving forward within the barrel 11; a pusher member 18 which pushes the plunger 17 toward the injection port 12 of the barrel 11; a driving force transmission unit 21 which transmits the driving force generated in the drive unit 20 to the pusher member 18; and a control unit 25 which controls these constituent units so that the inflow of the resin material into the barrel 11 is started and measurement of the resin material is completed when the load received by the drive unit 20 from the pusher member 18 located at a specified position reaches a predetermined value.

### TECHNICAL FIELD

The present invention relates to an injection device.

### BACKGROUND ART

An injection device is a device that continuously supplies a constant amount of resin material. For instance, an injection device is used for applications such as injecting resin material into a mold. In an injection device, a metering step of supplying a constant amount of resin material into the barrel after the injecting step is important in order to continuously inject resin material. Even if the same volume of resin material is injected from the injection device, if the density of the resin material is not stable inside the barrel, the amount of resin material to be injected will not be stable. In order to accurately inject a constant amount of resin material in one injecting step, the material pressure (internal pressure of the barrel) needs to be kept constant during the metering step.

Conventionally, in order to keep the material pressure constant during the metering step, metering methods such as the following have been proposed.

One is a method where the plunger is retreated at a constant speed while supplying the resin material, and the supply of the resin material is stopped when the plunger reaches a predetermined position (hereinafter also referred to as ‘Conventional Method 1’). Another is a method where the plunger is retreated to keep the material pressure constant inside the barrel while supplying the resin material, and the supply of the resin material is stopped when the plunger reaches a predetermined position (hereinafter also referred to as ‘Conventional Method 2’) (refer to Patent Document 1).

Patent Document 1: Japanese Unexamined Patent Application, Publication No. H02-120020

### DISCLOSURE OF THE INVENTION

### Problems to be Solved by the Invention

In Conventional Method 1, since the plunger retreats at a constant speed regardless of the supply speed of the resin material, there is a risk that air will enter the barrel, resulting in molding defects, depending on the speed of supplying the resin material. In particular, when using a liquid resin material with a low viscosity like silicone resin, air is likely to enter the barrel, and the occurrence of molding defects can be expected to increase. In Conventional Method 2, the material pressure can be kept constant from the start to the end of supplying the resin material to the barrel. However, in Conventional Method 2, parts such as a pressure sensor to measure the material pressure inside the barrel are necessary, which raises concerns about the increase in cost due to the increase in the number of parts.

An object of the present invention is to provide an injection device that can inject a constant amount of resin material in each injecting step, while suppressing the entry of air into the barrel and the increase in cost due to the increase in the number of parts. Means for Solving the Problems

One aspect of the present invention is an injection device that injects a resin material from an injection port provided at the tip side of a barrel, in which the injection device includes: a resin material inlet for introducing the resin material into the barrel; a drive unit that generates a driving force to inject the resin material filled in the barrel from the injection port; a plunger provided in the barrel so as to be able to advance and retreat in the axial direction, which retreats by the inflow of the resin material into the barrel from the resin material inlet, and injects the resin material filled in the barrel towards the injection port by advancing inside the barrel; a push-in member that pushes the plunger towards the injection port of the barrel; a driving force transmission unit that transmits a driving force generated by the drive unit to the push-in member; and a control unit that starts the inflow of the resin material from the resin material inlet into the barrel, and completes the metering of the resin material when the load received by the drive unit from the push-in member positioned at a prescribed position reaches a prescribed value. Effects of the Invention

With the injection device according to the present invention, a constant amount of resin material can be injected in each injecting step while suppressing the entry of air into the barrel and the increase in cost due to the increase in the number of parts.

### BRIEF DESCRIPTION OF THE DRAWINGS

FIG. 1 is a diagram illustrating a configuration of an injection device 1 of a first embodiment;

FIG. 2A is a diagram illustrating an injecting step and a pressure maintaining step of the first embodiment;

FIG. 2B is a diagram illustrating the injecting step and the pressure maintaining step of the first embodiment;

FIG. 3A is a diagram illustrating the metering step of the injection device 1 of the first embodiment;

FIG. 3B is a diagram illustrating the metering step of the injection device 1 of the first embodiment;

FIG. 3C is a diagram illustrating the metering step of the injection device 1 of the first embodiment;

FIG. 4 is a diagram illustrating control of adjusting a material pressure of the resin material;

FIG. 5 is a diagram illustrating control of changing the switching position;

FIG. 6A is a flowchart illustrating a processing procedure of a metering control program executed in a control unit 25 of the first embodiment;

FIG. 6B is a flowchart illustrating the processing procedure of the metering control program executed in the control unit 25 of the first embodiment;

FIG. 7A is a diagram illustrating a metering step of an injection device 1A of a second embodiment;

FIG. 7B is a diagram illustrating the metering step of the injection device 1A of the second embodiment;

FIG. 8A is a flowchart illustrating a processing procedure of a metering control program executed in the control unit 25 of the second embodiment;

FIG. 8B is a flowchart illustrating the processing procedure of the metering control program executed in the control unit 25 of the second embodiment; and

FIG. 9 is a diagram illustrating a configuration of an injection device 1 of a modified embodiment.

### PREFERRED MODE FOR CARRYING OUT THE INVENTION

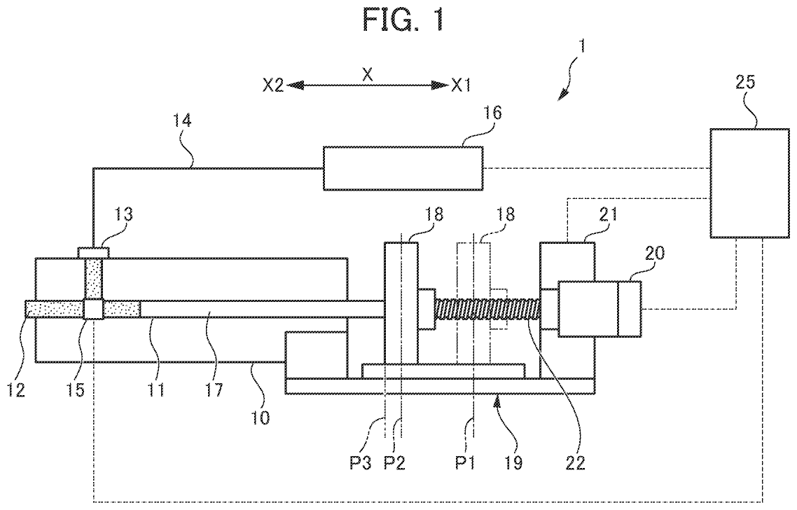

The following describes embodiments of the injection device according to the present invention. All drawings attached to this specification are schematically drawn, and the shape, scale, aspect ratio, etc. of each part have been modified or exaggerated from the actual object for ease of understanding. In the drawings attached to this specification, the X direction is defined as the front and rear (horizontal) direction of the injection device 1 illustrated in FIG. 1. In the X direction, the rear (right) direction is defined as X1 direction, and the front (left) direction is defined as X2 direction. In this specification, the term “ . . . direction” is also referred to as “ . . . side”.

### First Embodiment

The injection device 1 of the first embodiment configures an injection molding machine, along with a clamping device (none of which are illustrated). The injection molding machine is provided with a base (not illustrated) as well as the injection device 1 and the clamping device both installed on the base. The injection device 1 is a device that supplies resin material to the clamping device. In the injection device 1, a molding cycle for injecting the resin material filled in the barrel 11 (described later) into the clamping device includes a metering step, an injecting step, and a pressure maintaining step. The clamping device includes molds that can open and close, and produces molded products by applying pressure and heat to the resin material filled between the molds. The injection device 1 and the clamping device of the first embodiment are arranged side by side in the horizontal direction (X direction).

FIG. 1 is a diagram illustrating the configuration of the injection device 1 of the first embodiment. As illustrated in FIG. 1, the injection device 1 includes a barrel holder 10 (barrel 11), a nozzle 12, a resin material inlet 13, a material flow path 14, a flow path valve 15, and a material supply unit 16. In FIG. 1, only the configuration of the injection device 1 is described, and the base and the clamping device are omitted.

The barrel holder 10 is a housing that internally includes the barrel 11. The barrel 11 is a space where resin material is filled. A plunger 17 (described later) is inserted into the barrel 11. The nozzle (injection port) 12 is provided at the end of the front side (X2 side) of the barrel holder 10. The nozzle 12 is a part from which the resin material filled in the barrel 11 is injected, and is connected to the barrel 11. The tip of the nozzle 12 is connected to a sprue hole (not illustrated) of the clamping device.

A resin material inlet (hereinafter, also referred to as “inlet”) 13 is provided on the front side the barrel holder 10. The inlet 13 is an opening for allowing the resin material to flow into the barrel 11. The inlet 13 communicates with the barrel 11 via the flow path valve 15 (described later). One end of the material flow path 14 is connected to the inlet 13. The material flow path 14 is a flow path that communicates between the material supply unit 16 and the barrel 11. The other end of the material flow path 14 is connected to the material supply unit 16.

The flow path valve 15 is an electric valve provided in the barrel 11. The flow path valve 15 is configured with, for example, an electric three-way valve. When the flow path valve 15 is opened, the material flow path 14 communicates with the barrel 11, so that the resin material can be supplied from the material flow path 14 to the barrel 11 through the inlet 13. On the other hand, when the flow path valve 15 is closed, the material flow path 14 and the barrel 11 are not communicating, so the resin material can be injected from the nozzle 12. The opening and closing operation of the flow path valve 15 is controlled by the control unit. The flow path valve 15 is not limited to a three-way valve, and for example, may be configured with one or two two-way valves. In other words, the flow path valve 15 may have any configuration as long as the communication/non-communication between the material flow path 14 and the barrel 11 can be controlled.

The material supply unit 16 is a device that supplies resin material (for example, silicone resin) to the barrel 11. The resin material is supplied from the material supply unit 16 to the barrel 11 through the material flow path 14 and the inlet 13. The material supply unit 16 generates a supply pressure by a driving force such as a hydraulic pressure, a servo motor, etc., and supplies the resin material towards the barrel 11. In the material supply unit 16, the operations of supply and stoppage of the resin material are controlled by the control unit 25. The supply pressure refers to a pressure required for the material supply unit 16 to supply the resin material to the barrel 11. Specifically, the supply pressure is the sum of the material pressure (pressure inside the barrel) and the pressure loss occurring between the material supply unit 16 and the barrel 11.

The injection device 1 includes the plunger 17, a push-in member 18, a linear guide 19, a drive unit 20, a driving force transmission unit 21, and a control unit 25. The plunger 17 is a rod-shaped member that can move back and forth along the axial direction (X direction) of the barrel 11, inside the barrel 11. The plunger 17 is inserted into the barrel 11 except for the end part on the rear side (X1 side). When the resin material is filled in the barrel 11, the resin material filled in the barrel 11 is injected from the nozzle 12 by the advancement of the plunger 17. In the injection device 1 of the first embodiment, the end part on the rear side (X1 side) of the plunger 17 is always exposed outside the barrel 11. This brings about an advantage that an operator can easily check the position of the end part on the rear side of the plunger 17 during the injecting step, etc.

The push-in member 18 is a member that pushes the plunger 17 toward the nozzle 12 of the barrel 11. The push-in member 18 has a female screw (not illustrated) formed on the inner peripheral surface of the hole that penetrates in the thickness direction (X direction). The female screw of the push-in member 18 is engaged with a ball screw 22 (male screw) of the driving force transmission unit 21. In the injection device 1 of the first embodiment, the plunger 17 and the push-in member 18 are not connected (hereinafter also referred to as “non-connected”). Therefore, the push-in member 18 advances and comes into contact with the plunger 17, or retreats and separates from the plunger 17. The push-in member 18 is configured to be movable in the front-rear direction (X direction) along the linear guide 19. In the first and second embodiments (described later), the positions (P1 to P3) of the push-in member 18 will be described, based on the center in the thickness direction (X direction) of the push-in member 18.

The drive unit 20 is a device that generates a driving force for injecting the resin material filled in the barrel 11 from the nozzle 12. The drive unit 20 of the present embodiment is configured with a servo motor (including a servo amplifier, etc.). The driving force generated by the drive unit 20 is transmitted to the push-in member 18 via the driving force transmission unit 21 (described later). The push-in member 18 retreats in the X1 direction or advances in the X2 direction by the driving force generated by the drive unit 20.

Aside from the state of generating a driving force by itself, the drive unit 20 can be switched to the state of freely rotating by an external force. When the drive unit 20 is switched to the state of freely rotating by an external force, the drive unit 20 rotates by an external force transmitted through the ball screw 22. In this case, the rotation number of the servo motor rotating is detected by a pulse coder (not illustrated) and outputted to the control unit 25 (described later). Therefore, the control unit 25 can detect the position of the push-in member 18, based on the rotation number of the servo motor, not only when the drive unit 20 actively drives, but also when the drive unit 20 passively rotates by an external force.

The drive unit 20, configured with a servo motor, generates torque by supplying a current to maintain the position, even when the push-in member 18 is at a stop at a prescribed position P1 (described later). On the other hand, when the position of the push-in member 18 fluctuates due to an external force, the drive unit 20 causes the servo motor to generate torque to correct for the fluctuation by supplying a current to generate torque against the external force, thereby maintaining the position of the push-in member 18. These operations of the drive unit 20 are controlled by the control unit 25.

The driving force transmission unit 21 is a device that transmits a driving force of the drive unit 20 to the push-in member 18. The driving force transmission unit 21 includes the ball screw 22, a gear mechanism (not illustrated), etc. The ball screw 22 is a rod-shaped member that rotates by a driving force of the drive unit 20, and has a male screw (not illustrated) formed on its outer peripheral surface. The driving force transmission unit 21 of the present embodiment is configured with a single-axis ball screw 22.

The male screw of the ball screw 22 is engaged with the female screw (not illustrated) of the push-in member 18. The gear mechanism is a device that transmits a driving force of the drive unit 20 to the ball screw 22. By the driving force of the drive unit 20, when the ball screw 22 rotates forward (normal rotation), for instance, the push-in member 18 retreats (moves in the X1 direction). On the other hand, when the ball screw 22 rotates in reverse (reverse rotation), the push-in member 18 advances (moves in the X2 direction).

In the driving force transmission unit 21, aside from the state of rotating the ball screw 22 by the driving force of the drive unit 20, the ball screw 22 can be switched to the state of freely rotating by an external force. When the ball screw 22 is switched to the state of freely rotating, the ball screw 22 rotates by an external force applied from the push-in member 18. The rotation of the ball screw 22 is transmitted to the drive unit 20 via the gear mechanism. The switching of the driving force transmission unit 21 is controlled by the control unit 25.

The control unit 25 is electrically connected to the flow path valve 15, the material supply unit 16, the drive unit 20, and the driving force transmission unit 21 (gear mechanism), and is a device that controls operations of these units. The control unit 25 is configured with, for example, a microprocessor unit that includes a CPU (Central Processing Unit), memory, etc. Based on an application program for controlling the operation of the injection device 1 (for example, a metering control program to be described later), the control unit 25 controls the operation of each hardware, and executes a molding cycle consisting of an injecting step, a pressure maintaining step, and a metering step. Description will be provided below on the position control of the push-in member 18, which is executed by the control unit 25 in the injecting step and the pressure maintaining step.

The control unit 25 executes the injecting step and the pressure maintaining step during the injection of the resin material. The control unit 25 executes speed control in the injecting step, and executes pressure control in the pressure maintaining step. As illustrated in FIG. 1, in the injecting step, the control unit 25 causes the push-in member 18 to advance from the prescribed position P1 (described later) to a switching position P2 (described later). When the push-in member 18 advances, the plunger 17, which is pressed by the push-in member 18, also advances. At this time, the control unit 25 controls the drive unit 20 so that the plunger 17, which is pressed by the push-in member 18, advances at a uniform speed (speed control).

When the push-in member 18 reaches a predetermined position, the control unit 25 transitions from the speed control to the pressure control (pressure maintaining step). In this specification and the drawings, the predetermined position of transitioning from the speed control to the pressure control is referred to as “switching position P2”. FIG. 1 illustrates the state in which the push-in member 18 has advanced from the prescribed position P1 to the switching position P2. When the push-in member 18 advances to the switching position P2, the control unit 25 controls the drive unit 20 to apply a constant pressure to the resin material injected into the mold (pressure control). In this pressure control, the push-in member 18 advances to a fill completion position P3. In general, the switching position P2≠fill completion position P3. By executing the above pressure control over a predetermined period of time, the injection of the resin material is completed.

After completing the injection of the resin material, the control unit 25 executes a metering step. At the start of the metering step, the control unit 25 controls the drive unit 20 to cause the push-in member 18 to retreat to the prescribed position P1. Alternatively, the control unit 25 may start the metering step and supply the resin material to the barrel 11 when the push-in member 18 starts retreating. As mentioned earlier, since the plunger 17 and the push-in member 18 are not connected, even if the push-in member 18 retreats, the plunger 17 hardly retreats. The “prescribed position P1” refers to a position where the amount of the resin material filled in the barrel 11 becomes a predetermined injection amount set for one molding cycle. That is, the plunger 17 retreats as a result of the resin material being supplied to the barrel 11, and the barrel 11 is filled with at least a predetermined injection amount of resin material set for one molding cycle when the plunger 17 comes into contact with the push-in member 18 and the drive unit 20 receives a load.

The position of the prescribed position P1 can be calculated by: the stop position (origin position) of the push-in member 18+the rotation number of the ball screw 22+the pitch of the ball screw 22. As mentioned earlier, the rotation number of the ball screw (the rotation number of the servo motor) is detected by the pulse coder and outputted to the control unit 25. Therefore, the control unit 25 can detect the position of the push-in member 18 that is moving, based on the position before the movement of the push-in member 18 and the actual rotation number of the servo motor.

When the control unit 25 causes the push-in member 18 to retreat to the prescribed position P1, the control unit 25 opens the flow path valve 15 and controls the material supply unit 16 to supply the resin material to the barrel 11. As a result, the resin material is supplied from the material supply unit 16 to the barrel 11, and the metering of the resin material starts. When resin material is supplied to the barrel 11, the plunger 17 retreats in the X1 direction due to the material pressure of the resin material, and comes into contact with the push-in member 18 that has retreated to the prescribed position P1. Even after the plunger 17 comes into contact with the push-in member 18, the resin material continues to be supplied to the barrel 11, so the material pressure of the resin material acts upon the drive unit 20 through the plunger 17, the push-in member 18, and the ball screw 22 (the driving force transmission unit 21).

The control unit 25 increases or decreases the current value flowing to the servo motor in order to obtain torque required to maintain the position of the push-in member 18 against the external force received from the ball screw 22. The control unit 25 determines whether the load received by the drive unit 20 has reached a prescribed value, based on the increased or decreased current value. When the load received by the drive unit 20 reaches the prescribed value due to the material pressure of the resin material, the control unit 25 closes the flow path valve 15 and stops the supply of the resin material from the material supply unit 16 to the barrel 11. As a result, the metering of the resin material to the barrel 11 is completed.

In the metering step, when the load received by the drive unit 20 deviates from the allowable range, the control unit 25 executes control to change the stop position of the push-in member 18 from the prescribed position P1 so that the load received by the drive unit 20 falls within the allowable range. When the prescribed position is changed, the control unit 25 executes control to change the switching position P2 of transitioning from the injecting step to the pressure maintaining step. Here, the control unit 25 may change the switching position P2 by the same amount as the compensation amount for the prescribed position P1, or may change the switching position P2 by a compensation amount calculated based on the compensation amount of the prescribed position P1 and the compensation coefficient. Based on the compensation amount of the prescribed position P1, in the metering step, the control unit 25 executes control to change the supply pressure of the resin material supplied from the material supply unit 16 to the barrel 11. Details of the control executed by the control unit 25 in the metering step will be described later.

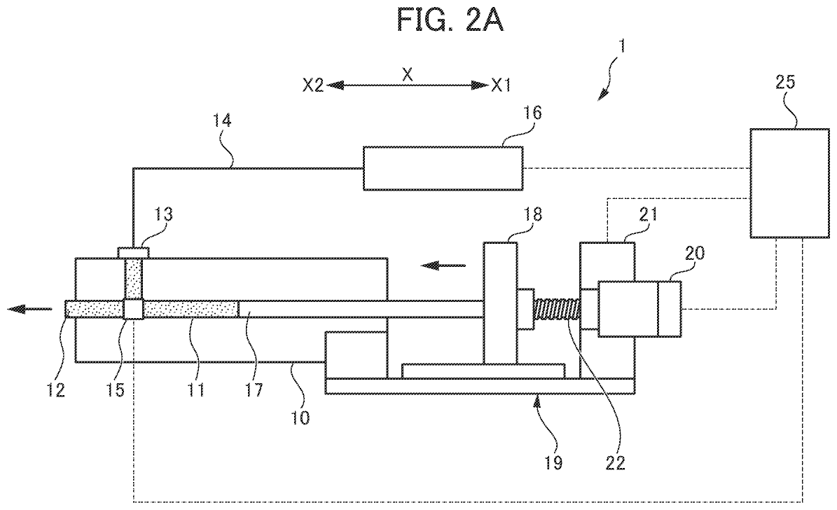

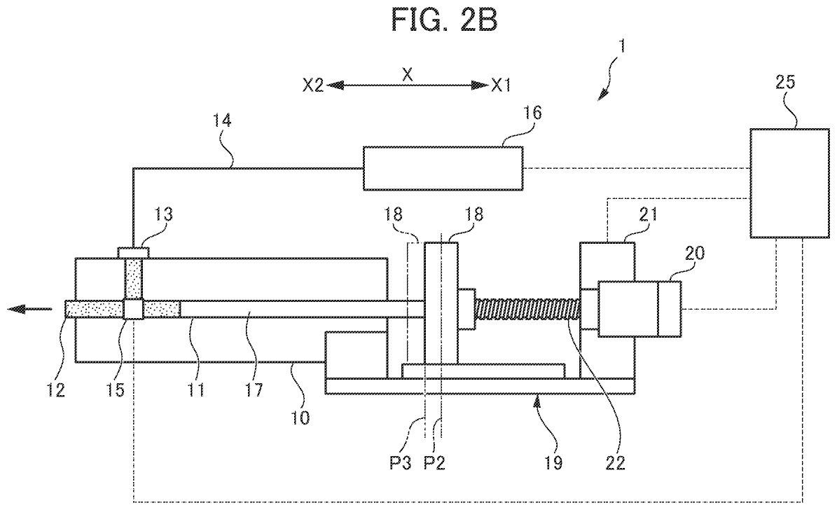

Next, a molding cycle (metering step, injecting step, pressure maintaining step) executed in the injection device 1 of the first embodiment will be described. In the actual molding cycle, the operation proceeds in the order of the metering step, the injecting step, and the pressure maintaining step, but here, the injecting step and the pressure maintaining step will be described first. FIGS. 2A and 2B are diagrams illustrating the injecting step and the pressure maintaining step of the first embodiment.

FIG. 2A illustrates the state in which the push-in member 18 is advancing in the injecting step. Before starting the injecting step, the resin material is filled in the barrel 11. The resin material is filled in the barrel 11 in the metering step (described later). In the injecting step, the control unit 25 controls the drive unit 20 to reverse the rotation of the ball screw 22 (the driving force transmission unit 21) and closes the flow path valve 15 (speed control). As a result, as illustrated in FIG. 2A, the push-in member 18 advances together with the plunger 17. When the plunger 17 advances, the resin material filled in the barrel 11 is injected toward the mold from the nozzle 12.

FIG. 2B illustrates the state in which the push-in member 18 has advanced to the switching position P2, transitioning from the injecting step to the pressure maintaining step. After completing the injecting step by causing the push-in member 18 to advance to the switching position P2, the control unit 25 further causes the push-in member 18 to advance to the fill completion position P3 and executes pressure control. By executing the pressure control for a predetermined period of time, the filling of the resin material is completed.

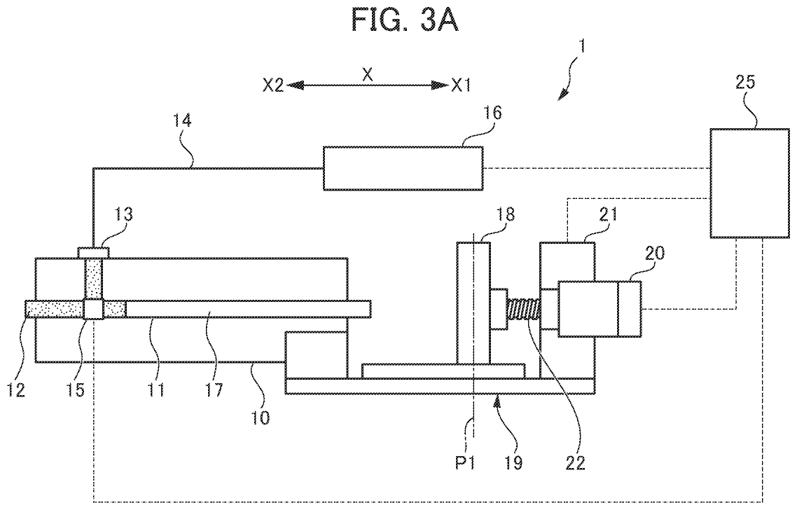

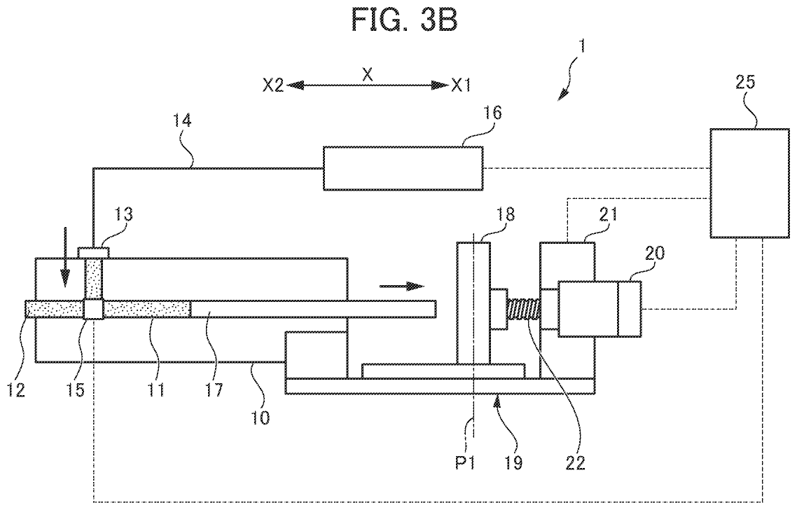

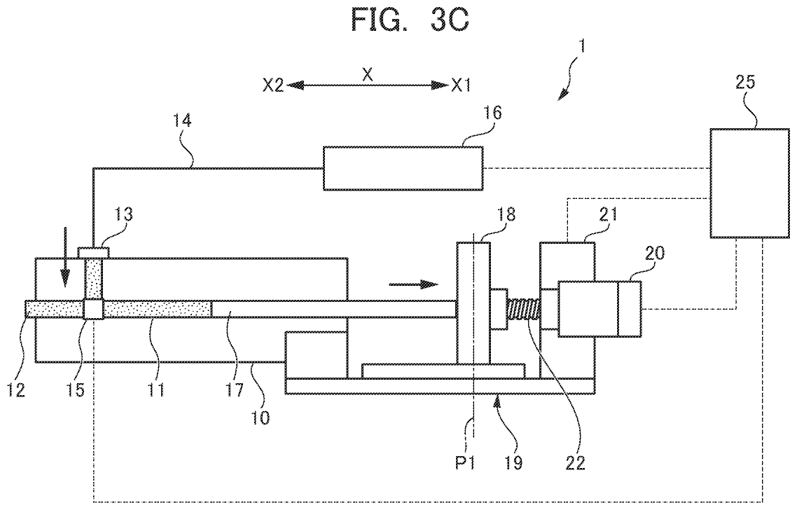

Next, the metering step will be described. FIGS. 3A to 3C are diagrams illustrating the metering step in the injection device 1 of the first embodiment. FIG. 3A illustrates the state in which the push-in member 18 has retreated to the prescribed position P1, in the metering step. After completing the filling of the resin material, the control unit 25 controls the drive unit 20 to cause the push-in member 18 to retreat to the prescribed position P1, as illustrated in FIG. 3A. Since the plunger 17 and the push-in member 18 are not connected, the plunger 17 barely retreats even if the push-in member 18 retreats.

FIG. 3B illustrates the state in which the plunger 17 has retreated due to the material pressure of the resin material, in the metering step. After the control unit 25 causes the push-in member 18 to retreat to the prescribed position P1, the control unit 25 opens the flow path valve 15 and controls the material supply unit 16 to supply the resin material to the barrel 11. As a result, the resin material is supplied from the material supply unit 16 to the barrel 11, and the metering of the resin material starts. When the resin material is supplied to the barrel 11, the plunger 17 retreats due to the material pressure of the resin material, as illustrated in FIG. 3B.

FIG. 3C illustrates the state in which the plunger 17 is in contact with the push-in member 18, in the metering step. As mentioned before, when the resin material is supplied from the material supply unit 16 to the barrel 11, the plunger 17 retreats due to the material pressure of the resin material, and comes into contact with the push-in member 18 that has retreated to the prescribed position P1, as illustrated in FIG. 3C. Even after the plunger 17 comes into contact with the push-in member 18, the resin material continues to be supplied to the barrel 11, so the material pressure of the resin material acts upon the drive unit 20 via the ball screw 22. When the load received by the drive unit 20 reaches a prescribed value due to the material pressure of the resin material, the control unit 25 closes the flow path valve 15 and stops the supply of the resin material from the material supply unit 16 to the barrel 11. As a result, the metering of the resin material to the barrel 11 is completed.

Next, other controls executed in the aforementioned metering step will be described.

### (Adjustment of Material Pressure of Resin Material)

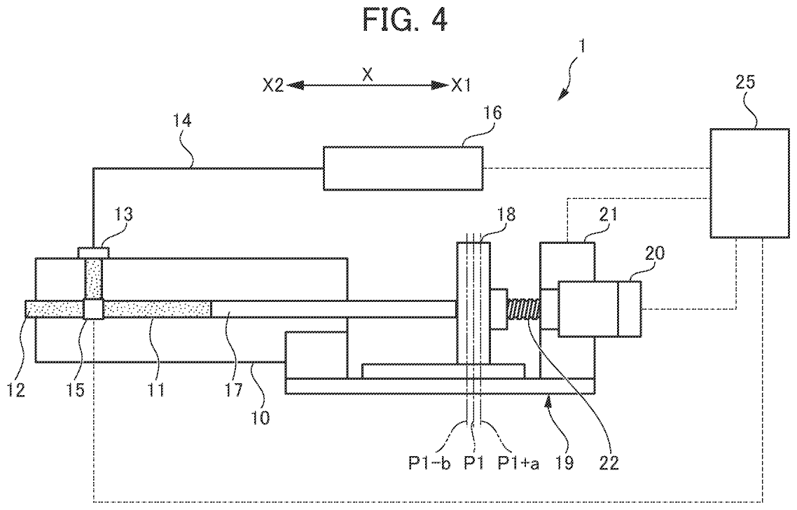

FIG. 4 is a diagram illustrating the control to adjust the material pressure of the resin material. If the load received by the drive unit 20 deviates from the allowable range after stopping the supply of the resin material to the barrel 11 by closing the flow path valve 15 during metering, it is possible that the internal pressure of the barrel 11 may be excessive or insufficient. Thus, if the load received by the drive unit 20 deviates from the allowable range, it becomes difficult to maintain a constant material pressure of the resin material in the barrel 11. Therefore, in the present embodiment, when the load received by the drive unit 20 deviates from the allowable range after stopping the supply of the resin material to the barrel 11 by closing the flow path valve 15 during metering, the control unit 25 executes control to retreat or advance the stop position of the push-in member 18 from the prescribed position P1 during metering.

Specifically, when the load received by the drive unit 20 exceeds the upper limit of the allowable range after stopping the supply of the resin material to the barrel 11 by closing the flow path valve 15 during metering, as illustrated in FIG. 4, the stop position of the push-in member 18 is changed to a position P1+a, which is on the X1 side of the prescribed position P1. This can reduce the material pressure of the resin material filled in the barrel 11. On the other hand, when the load received by the drive unit 20 is less than the lower limit of the allowable range after stopping the supply of the resin material to the barrel 11 by closing the flow path valve 15 during metering, as illustrated in FIG. 4, the stop position of the push-in member 18 is changed to a position P1-b, which is on the X2 side of the prescribed position P1. This can increase the material pressure of the resin material filled in the barrel 11.

The stop position of the push-in member 18 may be changed stepwise or continuously, based on a preset compensation amount. When the load received by the drive unit 20 deviates from the allowable range during metering, the control unit 25 executes the above control until the load received by the drive unit 20 falls within the allowable range, which always allows the material pressure of the resin material to be kept constant for each molding cycle. When the stop position of the push-in member 18 is changed, the control unit 25 stores the compensation amount in memory (not illustrated), and adjusts the stop position of the push-in member 18, based on the stored compensation amount, in the next molding cycle.

### (Change in Switching Position)

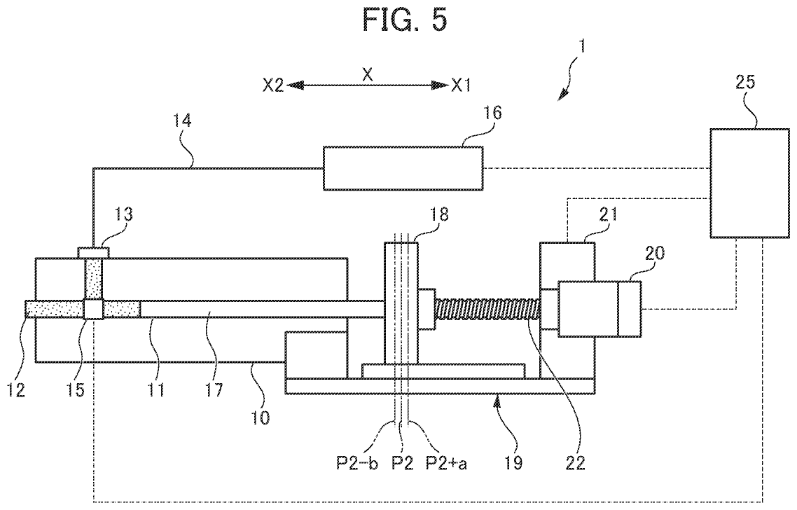

FIG. 5 is a diagram illustrating the control to change the switching position. In the metering step, when the stop position of the push-in member 18 has been changed, it is desirable to change the switching position P2 of transitioning from the speed control to the pressure control, in order to keep the injection amount of the resin material constant. Therefore, when the stop position of the push-in member 18 has been changed during metering (see FIG. 4), the control unit 25 executes control to change the switching position P2.

Specifically, during metering, when the stop position of the push-in member 18 has been changed to the position P1+a, which is on the X1 side of the prescribed position P1 (see FIG. 4), the switching position P2 is changed to a position P2+a, which is on the X1 side, as illustrated in FIG. 5. On the other hand, during metering, when the stop position of the push-in member 18 has been changed to the position P1−b, which is on the X2 side of the prescribed position P1 (see FIG. 4), the switching position P2 is changed to a position P2−b, which is on the X2 side, as illustrated in FIG. 5. By executing such control in the control unit 25, the injection amount of the resin material can be kept constant in the injecting step for each molding cycle.

In the present embodiment, when the stop position of the push-in member 18 is changed, as illustrated in FIG. 5, the same amount of change in the stop position of the push-in member 18 (+a or −b) is used as the compensation amount for the switching position P2, allowing the switching position P2 to be changed more quickly. On the other hand, in another embodiment, the switching position P2 may be changed based on the value obtained by multiplying the amount of change in the stop position of the push-in member 18 (+a or −b) by a preset compensation coefficient β. For example, when the stop position of the push-in member 18 after the change is Pita, and the compensation coefficient β is 0.8, the compensation amount for the switching position P2 is +α×0.8. According to this control, by changing the compensation coefficient depending on the injection amount of the resin material for each molding cycle, the switching position P2 can be adjusted more finely. In this control, the compensation coefficient β may be changed depending on the direction of moving the switching position P2. Note that, when the injection device 1 is applied to a sealant coating device or the like which does not require a pressure maintaining step, the change in the switching position of transitioning from the speed control to the pressure control is controlled as a change in the injection completion position.

### (Change in Supply Pressure of Resin Material)

When the stop position of the push-in member 18 needs to be retreated or advanced from the prescribed position P1 during metering, it is also possible that the supply pressure of the resin material supplied from the material supply unit 16 to the barrel 11 may be excessive or insufficient. Therefore, in the present embodiment, when the stop position of the push-in member 18 is changed from the prescribed position P1 during metering, the control unit 25 executes control to change the supply pressure of the resin material supplied from the material supply unit 16 to the barrel 11.

Specifically, when the stop position of the push-in member 18 is retreated from the prescribed position P1 during metering, the supply pressure of the resin material supplied from the material supply unit 16 to the barrel 11 is lowered in the next molding cycle. On the other hand, when the stop position of the push-in member 18 is advanced from the prescribed position P1 during metering, the supply pressure of the resin material supplied from the material supply unit 16 to the barrel 11 is increased in the next molding cycle. By executing such control, the material pressure of the resin material can be kept constant for each molding cycle. Note that the adjustment of the material pressure of the resin material, the change in the switching position, and the control of the change in the supply pressure of the resin material described above can also be applied to an injection device 1A in the second embodiment to be described later.

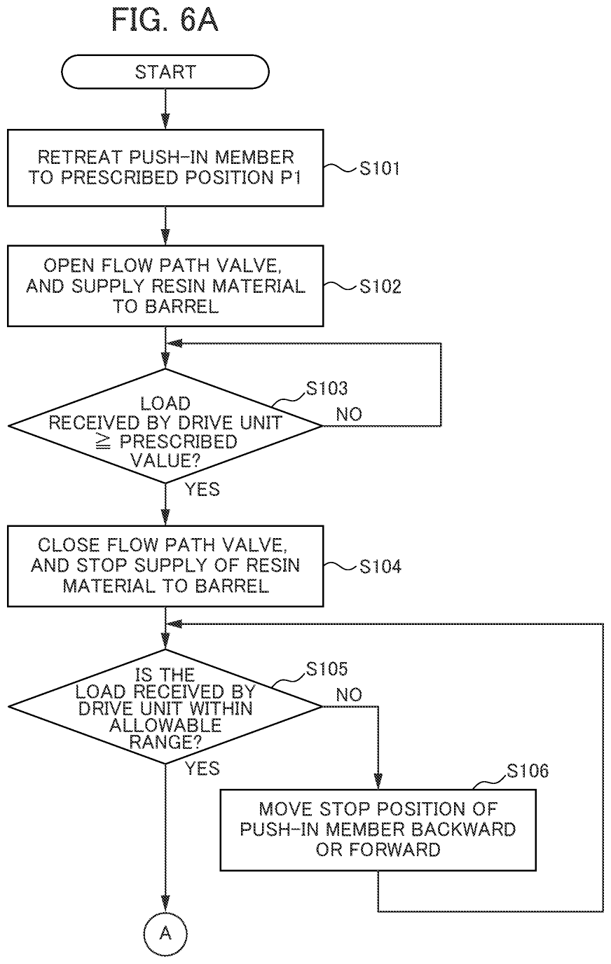

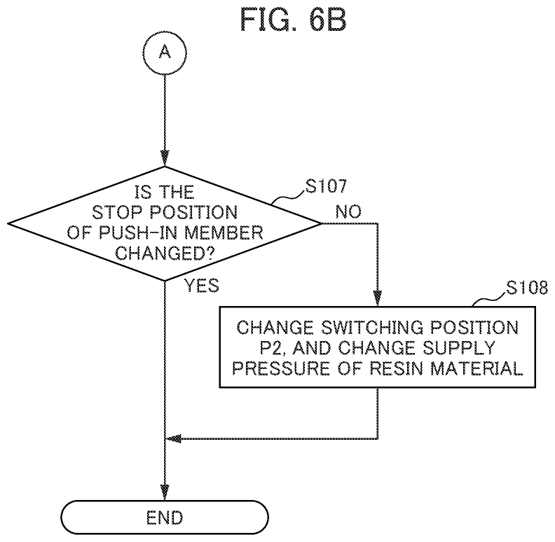

Next, the processing content of a metering control program executed by the control unit 25 of the first embodiment will be described, based on the flowcharts illustrated in FIGS. 6A and 6B. FIGS. 6A and 6B are flowcharts illustrating the processing procedure of the metering control program executed by the control unit 25 of the first embodiment.

In Step S101 illustrated in FIG. 6A, the control unit 25 (see FIG. 1) controls the drive unit 20 to cause the push-in member 18 to retreat to the prescribed position P1.

In Step S102, the control unit 25 opens the flow path valve 15 and controls the material supply unit 16 to supply the resin material to the barrel 11. As a result, the resin material is supplied from the material supply unit 16 to the barrel 11, and the metering of the resin material starts. When the resin material is supplied to the barrel 11, the plunger 17 retreats due to the material pressure of the resin material (see FIG. 3B).

In Step S103, the control unit 25 determines whether the load received by the drive unit 20 has reached a prescribed value. In Step S103, if the control unit 25 determines that the load received by the drive unit 20 has reached the prescribed value, the processing proceeds to Step S104. On the other hand, in Step S103, if the control unit 25 determines that the load received by the drive unit 20 has not reached the prescribed value, the processing returns to Step S103.

In Step S104 (Step S103: YES), the control unit 25 closes the flow path valve 15 and stops the supply of the resin material from the material supply unit 16 to the barrel 11. As a result, the metering of the resin material to the barrel 11 is completed.

In Step S105, the control unit 25 determines whether the load received by the drive unit 20 is within the allowable range. In Step S105, if the control unit 25 determines that the load received by the drive unit 20 is within the allowable range, the processing proceeds to Step S107 (see FIG. 6B). On the other hand, in Step S105, if the control unit 25 determines that the load received by the drive unit 20 is outside the allowable range, the processing proceeds to Step S106.

In Step S106 (Step S105: NO), the control unit 25 retreats or advances the stop position of the push-in member 18 from the prescribed position P1. The control unit 25 executes the control in Step S106 until determining in Step S105 that the load received by the drive unit 20 is within the allowable range.

In Step S107 (Step S105: YES) illustrated in FIG. 6B, the control unit 25 determines whether the stop position of the push-in member 18 has been changed. In Step S107, if the control unit 25 determines that the stop position of the push-in member 18 has not been changed, the processing of this flowchart ends. On the other hand, in Step S107, if the control unit 25 determines that the stop position of the push-in member 18 has been changed, the processing proceeds to Step S108.

In Step S108 (Step S107: NO), the control unit 25 changes the switching position P2, based on the changed stop position of the push-in member 18. The control unit 25 changes the supply pressure of the resin material supplied from the material supply unit 16 to the barrel 11, based on the changed stop position of the push-in member 18. After completing the processing in Step S108, the processing of this flowchart ends.

For example, the following effects can be achieved with the injection device 1 of the first embodiment described above. In the injection device 1 of the first embodiment, the control unit 25 executes control to cause the plunger 17 to retreat due to the material pressure of the resin material, and complete the metering of the resin material when the load received by the drive unit 20 reaches the prescribed value due to the material pressure of the resin material. Therefore, the entry of air into the barrel 11 can be suppressed, as compared to a method of forcibly retreating the plunger with a plunger driving device. In particular, in the case of low viscosity liquid resin material such as silicone, the entry of air into the barrel 11 can be more effectively suppressed. Since there is no need to control the position of the plunger while measuring the material pressure in the barrel 11 using a pressure sensor, not only the pressure sensor but also the connecting member for connecting the plunger and the plunger drive device become unnecessary. Therefore, according to the injection device 1 of the first embodiment, a constant amount of resin material can be injected in each injecting step, while suppressing the entry of air into the barrel 11 or the increase in cost due to the increase in the number of parts.

In the injection device 1 of the first embodiment, when the load received by the drive unit 20 deviates from the allowable range, the control unit 25 executes control to retreat or advance the stop position of the push-in member 18 from the prescribed position P1 so that the load received by the drive unit 20 falls within the allowable range. According to this control, the material pressure of the resin material filled in the barrel 11 is adjusted depending on the amount by which the load received by the drive unit 20 deviates from the allowable range, so the material pressure of the resin material can be kept constant for each molding cycle.

In the injection device 1 of the first embodiment, when the control unit 25 executes control to retreat or advance the stop position of the push-in member 18 from the prescribed position P1, the control unit 25 executes control to change the switching position P2 of transitioning from the speed control to the pressure control, so the injection amount of the resin material can be kept constant for each molding cycle in the injecting step.

In the above control, the same amount of change in the stop position of the push-in member 18 is used as the compensation amount for the switching position P2, whereby the switching position P2 can be changed more quickly. In the above control, the switching position P2 may be changed based on the value obtained by multiplying the amount of change in the stop position of the push-in member 18 by a preset compensation coefficient β. In this case, the compensation coefficient β is changed depending on the amount of the resin material injected for each molding cycle, whereby the switching position P2 can be adjusted more finely.

In the injection device 1 of the first embodiment, when the control unit 25 changes the stop position of the push-in member 18 from the prescribed position P1 during metering, the control unit 25 executes control to change the supply pressure of the resin material supplied from the material supply unit 16 to the barrel 11, so the material pressure of the resin material can be kept constant for each molding cycle.

### Second Embodiment

An injection device 1A of the second embodiment differs from the first embodiment in that the plunger 17 is connected to the push-in member 18. Other configurations of the injection device 1A of the second embodiment are the same as those in the first embodiment. Therefore, in the description and drawings of the second embodiment, the same reference numerals as the first embodiment are used for equivalent components, and repeated descriptions are omitted. The basic configuration of the injection device 1A of the second embodiment is the same as that in FIG. 1. In the injection device 1A of the second embodiment, the injecting step and the pressure maintaining step in the molding cycle (see FIGS. 2A and 2B) are the same as those in the first embodiment, so only the metering step will be described.

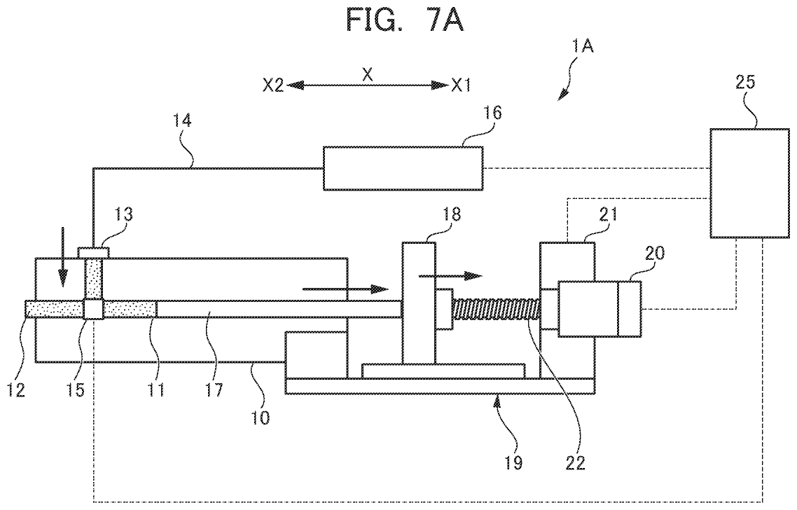

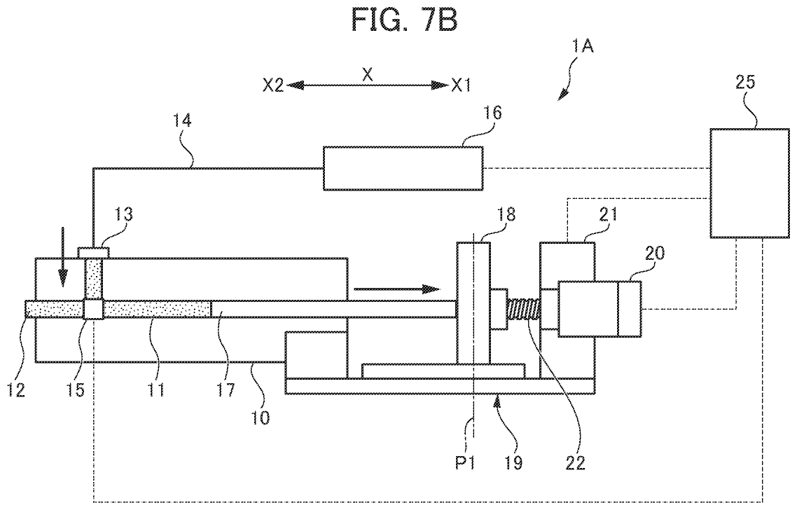

FIGS. 7A and 7B are diagrams illustrating the metering step of the injection device 1A of the second embodiment. FIG. 7A illustrates the state immediately after starting the metering step. After completing the injection of the resin material, the control unit 25 switches the drive unit 20 and the ball screw 22 to the state of freely rotating by an external force while maintaining the positions of the plunger 17 and the push-in member 18.

Next, the control unit 25 opens the flow path valve 15 and controls the material supply unit 16 to supply the resin material to the barrel 11. As a result, the resin material is supplied from the material supply unit 16 to the barrel 11, and the metering of the resin material starts. When the resin material is supplied to the barrel 11, the plunger 17 and the push-in member 18 retreat due to the material pressure of the resin material, as illustrated in FIG. 7A. At this time, the drive unit 20 and the ball screw 22 rotate in accordance with the retreat of the plunger 17 and the push-in member 18. In the following description, the plunger 17 and the push-in member 18 are collectively referred to as the “push-in member 18”.

FIG. 7B illustrates the state in which the push-in member 18 has retreated to a prescribed position together with the plunger 17, in the metering step. As illustrated in FIG. 7B, it is determined whether the push-in member 18 has retreated to the prescribed position P1 due to the material pressure of the resin material. As mentioned above, the rotation number of the ball screw is detected as the rotation number of the servo motor by the pulse coder (not illustrated), so the control unit 25 can detect the position of the moved push-in member 18, based on the position before moving the push-in member 18 and the actual rotation number of the servo motor.

When the push-in member 18 retreats to the prescribed position P1, the control unit 25 releases the drive unit 20 and the ball screw 22 from the state of freely rotating by an external force. Then, the control unit 25 maintains the push-in member 18 at the prescribed position P1 by supplying a current, to the drive unit 20, for maintaining the position of the push-in member 18. Even after the push-in member 18 has retreated to the prescribed position P1, the resin material continues to be supplied to the barrel 11, so the material pressure of the resin material acts upon the drive unit 20 through the ball screw 22. When the load received by the drive unit 20 reaches a prescribed value due to the material pressure of the resin material, the control unit 25 closes the flow path valve 15 and stops the supply of the resin material from the material supply unit 16 to the barrel 11. As a result, the metering of the resin material to the barrel 11 is completed.

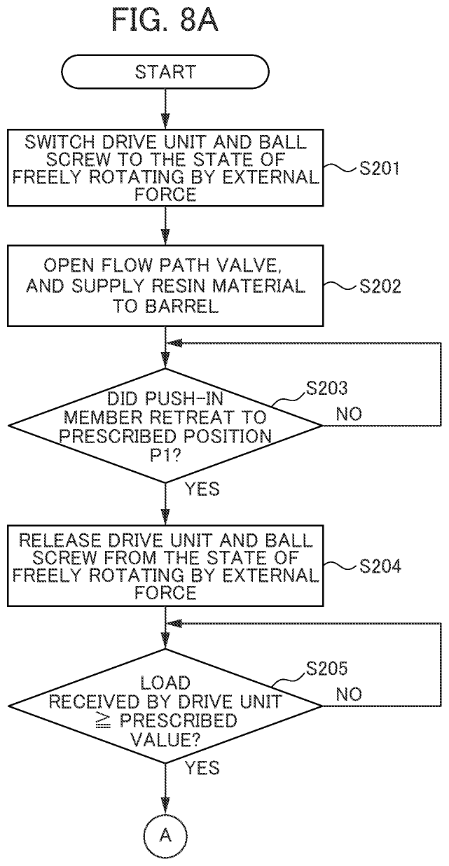

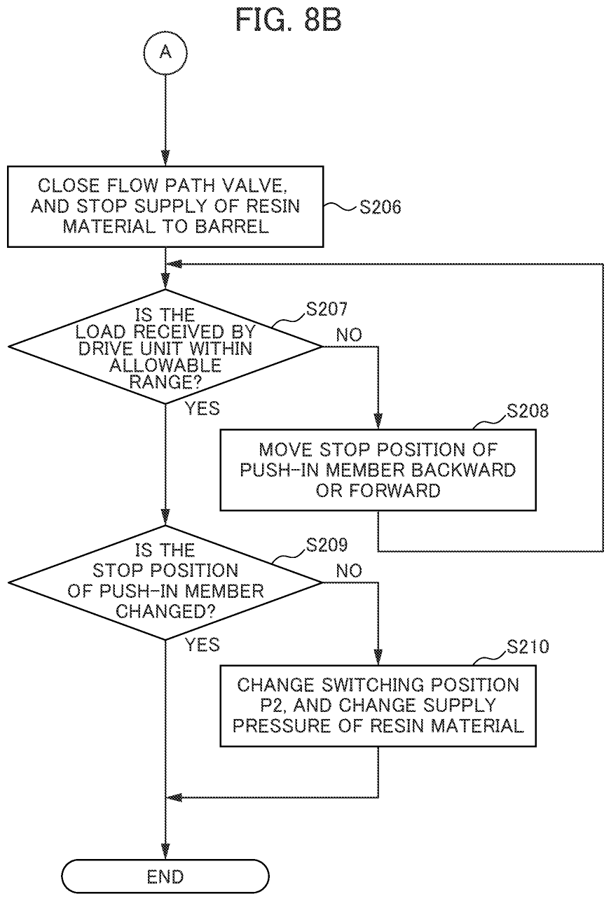

Next, the content of the metering control program executed by the control unit 25 of the second embodiment will be described, based on the flowcharts illustrated in FIGS. 8A and 8B. FIGS. 8A and 8B are flowcharts illustrating the processing procedure of the metering control program executed by the control unit 25 of the second embodiment.

In Step S201 illustrated in FIG. 8A, the control unit 25 (see FIG. 1) switches the drive unit 20 and the ball screw 22 to the state of freely rotating by an external force.

In Step S202, the control unit 25 opens the flow path valve 15 and controls the material supply unit 16 to supply the resin material to the barrel 11. As a result, the resin material is supplied from the material supply unit 16 to the barrel 11, and the metering of the resin material starts. When the resin material is supplied to the barrel 11, the push-in member 18 retreats due to the material pressure of the resin material (see FIG. 7A).

In Step S203, the control unit 25 determines whether the push-in member 18 has retreated to the prescribed position P1. In Step S203, if the control unit 25 determines that the push-in member 18 has retreated to the prescribed position P1, the processing proceeds to Step S204. On the other hand, in Step S203, if the control unit 25 determines that the push-in member 18 has not retreated to the prescribed position P1, the processing returns to Step S203.

In Step S204 (Step S203: YES), the control unit 25 releases the drive unit 20 and the ball screw 22 from the state of freely rotating by an external force.

In Step S205, the control unit 25 determines whether the load received by the drive unit 20 has reached a prescribed value. In Step S205, if the control unit 25 determines that the load received by the drive unit 20 has reached the prescribed value, the processing proceeds to Step S206 (see FIG. 8B). On the other hand, in Step S205, if the control unit 25 determines that the load received by the drive unit 20 has not reached the allowable value, the processing returns to Step S205.

In Step S206 (Step S205: YES) illustrated in FIG. 8B, the control unit 25 closes the flow path valve 15 and stops the supply of the resin material from the material supply unit 16 to the barrel 11. As a result, the metering of the resin material to the barrel 11 is completed.

In Step S207, the control unit 25 determines whether the load received by the drive unit 20 is within the allowable range. In Step S207, if the control unit 25 determines that the load received by the drive unit 20 is within the allowable range, the processing proceeds to Step S209. On the other hand, in Step S207, if the control unit 25 determines that the load received by the drive unit 20 is outside the allowable range, the processing proceeds to Step S208.

In Step S208 (Step S207: NO), the control unit 25 retreats or advances the stop position of the push-in member 18 from the prescribed position P1.

In Step S209 (Step S207: YES), the control unit 25 determines whether the stop position of the push-in member 18 has been changed. In Step S209, if the control unit 25 determines that the stop position of the push-in member 18 has not been changed, the processing of this flowchart ends. On the other hand, in Step S209, if the control unit 25 determines that the stop position of the push-in member 18 has been changed, the processing proceeds to Step S210.

In Step S210 (Step S209: NO), the control unit 25 changes the switching position P2, based on the changed stop position of the push-in member 18. The control unit 25 changes the supply pressure of the resin material supplied from the material supply unit 16 to the barrel 11, based on the changed stop position of the push-in member 18. After completing the processing in Step S210 is completed, the processing of this flowchart ends. Effects similar to those of the injection device 1 of the first embodiment can be achieved by the injection device 1A of the second embodiment as described above.

Although the embodiments of the present invention have been described above, the present invention is not limited to the described embodiments and can be variously modified and changed as in the modified forms described later, and these are also included within the technical scope of the present invention. The effects described in the embodiments are merely a list of the most suitable effects arising from the present invention and are not limited to those described in the embodiments. The above-described embodiments and a modified embodiment described below can also be used in combination as appropriate, but a detailed description is omitted. In the following description, the first and second embodiments are collectively referred to as “embodiments”.

### Modified Embodiment

In the embodiments, with regard to the control to adjust the material pressure of the resin material, the control to change the switching position P2, and the control to change the supply pressure of the resin material, all of these controls may not necessarily be executed, one or more of the controls may be executed in combination, or these controls may not be executed. The embodiments have been described for the configuration of the injection device, in which the control unit 25 executes the control to start/stop supplying the resin material (hereinafter referred to as “material supply control”), and the control of the drive unit 20, the control to open/close the flow path valve 15, and the control of the driving force transmission unit 21 (hereinafter referred to as “drive control”); however, the present invention is not limited thereto. In the injection device, the material supply control and the drive control may be executed by separate control units. In this case, for example, the timing of the material supply control and the timing of the drive control can be synchronized by outputting control signals from a control unit that executes the drive control to another control unit that executes the material supply control.

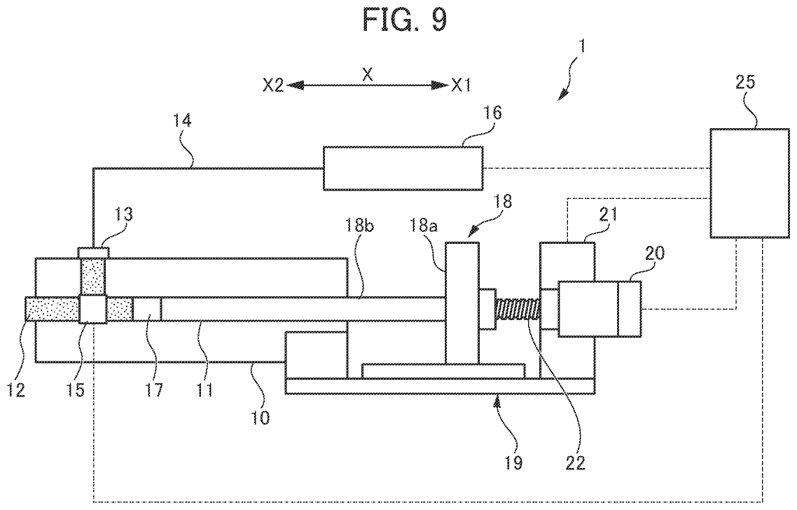

In the embodiments, the plunger 17 retreats due to the material pressure of the resin material supplied to the barrel 11. Therefore, if the diameter of the plunger 17 is larger than a certain size, the plunger 17 needs to be shortened. FIG. 9 is a diagram illustrating the configuration of the injection device 1 of the modified embodiment. As illustrated in FIG. 9, if the diameter of the plunger 17 is larger than a certain size, the plunger 17 may be shortened and the push-in member 18 may be configured with a plate-like first push-in member 18a and a tubular second push-in member 18b. In the push-in member 18 illustrated in FIG. 9, the first push-in member 18a and the second push-in member 18b may not be connected or may be connected. The plunger 17 and the push-in member 18 may not be connected as in the first embodiment, or may be connected as in the second embodiment.

The embodiments have been described for the configuration of the driving force transmission unit 21, in which the driving force of the drive unit 20 is transmitted to the ball screw 22 via the gear mechanism; however, the driving force of the drive unit 20 may also be directly transmitted to the ball screw 22 without using a gear mechanism. The embodiments have been described for the configuration, in which the drive unit 20 is configured with a servo motor; however, the drive unit 20 may be configured with a hydraulic mechanism, for example. The embodiments have been described for the example, in which the injection device is applied to an injection molding machine; however, the injection device can also be applied to a robot provided with a dispenser for injecting a resin material toward a target object, for example.

The embodiments have been described for the example, in which the position of the push-in member 18 is detected based on the rotation number of the servo motor configuring the drive unit 20; however, the position of the push-in member 18 may be detected using an external sensor such as a photoelectric sensor or a camera. The embodiments have been described for the example, in which the driving force transmission unit 21 is configured with a single-axis ball screw; however, the driving force transmission unit 21 may be configured with a two-axis ball screw or a ball screw having three or more axes. The embodiments have been described for the example, in which the injection device and the clamping device are arranged in the horizontal direction; however, the injection device and the clamping device can also be arranged in the vertical direction.

### EXPLANATION OF REFERENCE NUMERALS

1, 1a: injection device, 10: barrel holder, 11: barrel, 12: nozzle, 13: resin material inlet, 14: material flow path, 15: flow path valve, 16: material supply unit, 17: plunger, 18: push-in member, 19: linear guide, 20: drive unit, 21: driving force transmission unit, 22: ball screw, 25: control unit

1. An injection device that injects a resin material from an injection port provided at a tip of a barrel, the injection device comprising:
a resin material inlet for introducing the resin material into the barrel;
a drive unit that generates a driving force to inject the resin material filled in the barrel from the injection port;
a plunger that is provided so as to be able to advance and retreat in an axial direction of the barrel, retreats due to an inflow of the resin material from the resin material inlet into the barrel, and advances within the barrel to inject the resin material filled in the barrel towards the injection port;
a push-in member that pushes the plunger towards the injection port of the barrel;
a driving force transmission unit that transmits the driving force generated by the drive unit to the push-in member; and
a control unit that controls each unit so as to start the inflow of the resin material from the resin material inlet into the barrel, and complete metering of the resin material when a load received by the drive unit from the push-in member positioned at a prescribed position reaches a prescribed value.

2. The injection device according to claim 1,
wherein the push-in member is not connected to the plunger, and
wherein the control unit controls each unit so as to start the inflow of the resin material from the resin material inlet into the barrel, and complete the metering of the resin material when the push-in member has retreated to the prescribed position by the drive unit, and the load received by the drive unit has reached the prescribed value.

3. The injection device according to claim 1,
wherein the push-in member is connected to the plunger, and
wherein the control unit controls each unit so as to start the inflow of the resin material from the resin material inlet into the barrel, and complete the metering of the resin material when the push-in member has retreated to the prescribed position by the plunger, and the load received by the drive unit has reached the prescribed value.

4. The injection device according to claim 1,
wherein, when the load received by the drive unit falls outside an allowable range, the control unit changes a stop position of the push-in member from the prescribed position so that the load falls within the allowable range.

5. The injection device according to claim 4,
wherein, when the stop position of the push-in member is changed, the control unit changes an injection completion position or a switching position of transitioning from an injecting step to a pressure maintaining step.

6. The injection device according to claim 5,
wherein the control unit changes the injection completion position or the switching position by the same amount as an amount by which the stop position of the push-in member has been changed from the prescribed position.

7. The injection device according to claim 5,
wherein the control unit calculates a compensation amount for the injection completion position or the switching position, based on the amount by which the stop position of the push-in member has been changed from the prescribed position and a compensation coefficient.

8. The injection device according to claim 4, further comprising:
a resin material supply unit that supplies the resin material to the barrel,
wherein the control unit changes a supply pressure of the resin material supplied from the resin material supply unit to the barrel in a next metering step, based on a compensation amount for the prescribed position.
